(19) United States
(12) Patent Application Publication
(10) Pub. No.: US 2023/0213673 A1
(43) Pub. Date: Jul. 6, 2023

(54) FREQUENCY RESPONSE ESTIMATION METHOD TO COMPENSATE FOR CHANNEL DIFFERENCES IN DISTRIBUTED ACOUSTIC SENSING SYSTEMS

(71) Applicant: ASELSAN ELEKTRONIK SANAYI VE TICARET ANONIM SIRKETI, Ankara (TR)

(72) Inventors: Mustafa AKUR, Ankara (TR); Abdulsamet DAGASAN, Ankara (TR); Muhammet Emre SAHINOGLU, Ankara (TR)

(73) Assignee: ASELSAN ELEKTRONIK SANAYI VE TICARET ANONIM SIRKETI, Ankara (TR)

(21) Appl. No.: 18/081,727

(22) Filed: Dec. 15, 2022

(30) Foreign Application Priority Data
Dec. 30, 2021 (TR) 2021/021925

(51) Int. Cl. G01V 1/36; G01V 1/00; G01V 1/22

(52) U.S. Cl. CPC G01V 1/36; G01V 1/001; G01V 1/226

(57) ABSTRACT

A frequency response estimation method to compensate for channel differences in distributed acoustic sensing systems include two compensation algorithms, online and offline, and these two compensation algorithms are presented to generate standardized mel-frequency features, as an input to neural networks. By this scheme, the variance of mel-frequency feature space is decreased and normalized among different channels, which enables to use less training data and smaller architectures for classification and anomalous event detection tasks.

CROSS REFERENCE OF THE RELATED APPLICATION

The present invention is based on and claims foreign priority to TR 2021/021925 filed on Dec. 30, 2021, the entire content of which is incorporated herein by reference.

### TECHNICAL FIELD

The present invention is related with frequency response estimation method to compensate for channel differences in distributed acoustic sensing systems.

### BACKGROUND

In the state of art, channels are handled independently from each other. The neural network models trained with these techniques require a lot of data to cover the variation to be encountered in the field. The application numbered CN112147590A discloses a channel equalization method based on response estimation frequency domain fitting. The method takes into account the inconsistency of all signal receiving channels, reduces the influence of noise on the channel response, and eliminates the problems of zero divisor and amplified out-of-band noise in the frequency domain quotient operation. Channel equalization method does not mention about converting the data obtained from all channels into a standard version as if they were taken from a single channel, therefore the method falls short of solving the problem of using too much data to cover the variation in the field of the neural network models trained by dealing with the channels independently from each other.

### SUMMARY

The invention proposes frequency response estimation method to compensate for channel differences in distributed acoustic sensing systems. In the method, two compensation algorithms are presented to generate standardized mel-frequency features, as an input to the neural networks. By this scheme, the variance of mel-frequency feature space is decreased and normalized among different channels. This enables us to use less training data, smaller architectures for classification and anomalous event detection tasks.

### BRIEF DRSCRIPTION OF THE DRAWINGS

FIG. 1 shows a sample of visualized DAS (Distributed Acoustic Sensing) data using SNR (Signal to Noise Ratio) values during a vehicle passage.

FIG. 2 shows block diagram for offline frequency response estimation algorithm.

FIG. 3 shows mel-spectrogram image of digging activity at channel 280 (record offset 229).

FIG. 4 shows mel-spectrogram image of digging activity at channel 327 (record offset 276).

FIG. 5 shows block diagram for online frequency response estimation algorithm.

FIG. 6 shows block diagram for frequency response difference compensation block.

FIG. 7 shows mel-frequency features normalization (with online compensation algorithm) visualized.

### DETAIL DESCRIPTION OF THE EMBODIMENTS

Distributed acoustic sensing (DAS) systems are based on the principle of accurately measuring Rayleigh scattered reflections of highly coherent light-pulses sent through fiber optic cable. In the interrogator, the level of the laser pulse reflected as a result of Rayleigh scattered is periodically measured. Each measurement of the Rayleigh back scattered laser pulse corresponds to a location along fiber. From now on, these locations will be named as channels. We measure back-scattered laser pulse every 100 ns, hence each channel covers 10 m interval along fiber (this result obtained using the light speed in the glass). For a field where 10 km fiber installed we would obtain 1000 channel signal. When the laser pulse, sent from sensor, returns from the end of the fiber optic cable, a new laser pulse is sent. Then new measurements are taken for new time point. This enables us to detect acoustic vibrations along the fiber optic cable installed. For channels with no activity, we expect to get similar measurement values at different time stamps. However, for channels where activity occurs at nearby, we expect to see large deviations at different time stamps.

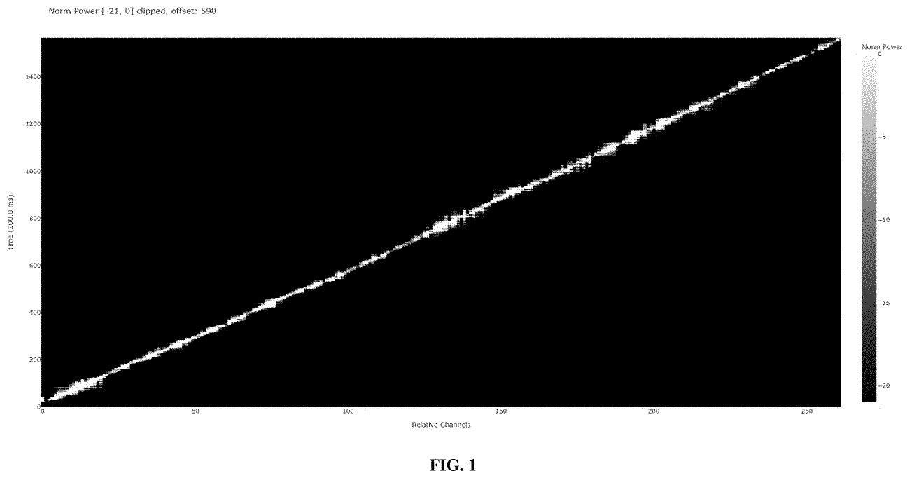

A sample of DAS data visualized using SNR (Signal to Noise Ratio) values is given in FIG. 1. In FIG. 1, we see a car, during passage of 2500 m route. The white lines (high SNR) correspond to vehicle trajectory. As can be observed from FIG. 1, during vehicle movement acoustic vibrations increase along the fiber optic cable. Hence, we obtain high SNR at nearby channels where car passes.

As we move along the fiber optic cable, sensitivity of the DAS systems decrease. This results in different frequency responses for each channel. We propose two methods to compensate for decreasing sensitivity along fiber, by estimating frequency response of each channel. First method uses an offline algorithm to estimate frequency response of each channel, second method uses an online algorithm to do so.

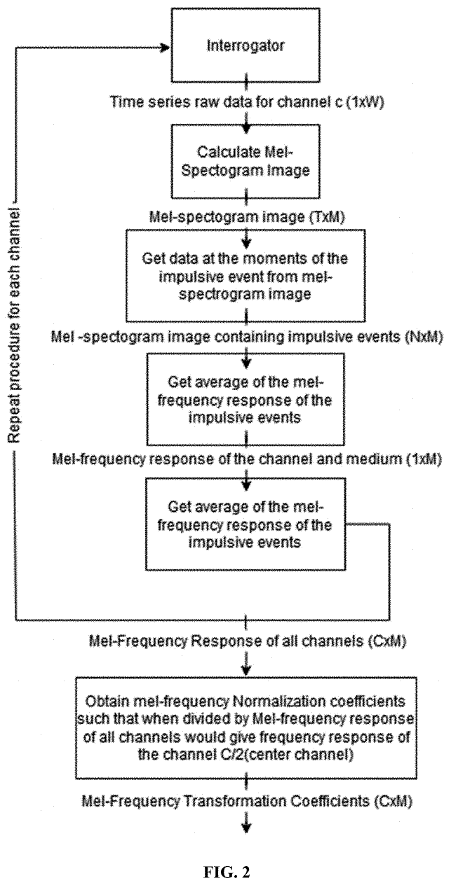

To estimate frequency response of different channels, offline frequency response estimation algorithm applies following operations consecutively. The block diagram of the offline frequency response estimation algorithm can be seen in FIG. 2.

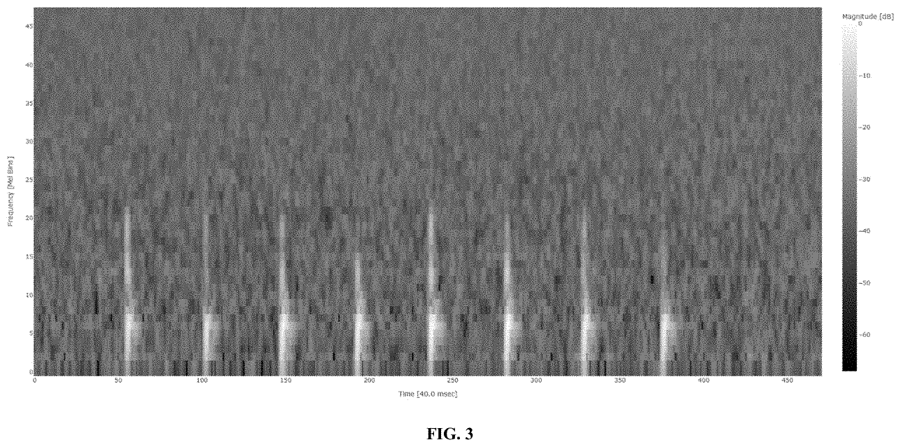

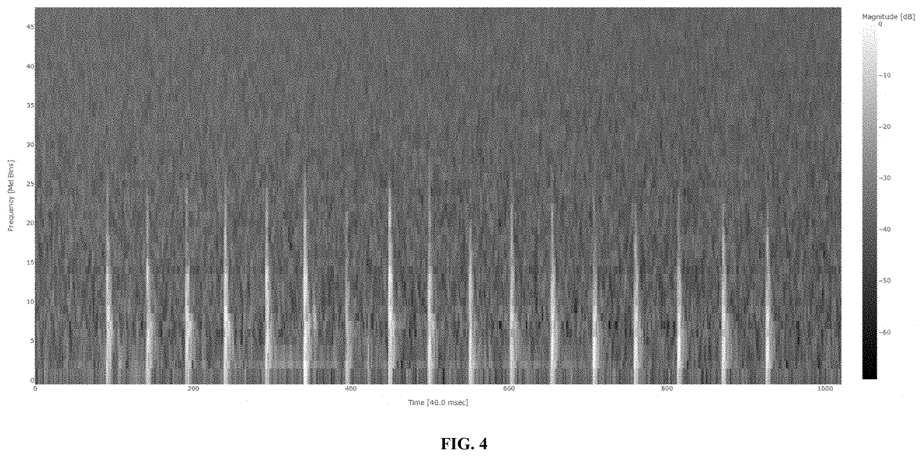

For a total of L channels (every K^{th} channel fiber optic cable installed-the smaller the K, the better-) get N recording of an impulsive event like digging. In FIG. 3 and FIG. 4, we show the mel-spectrogram image for a digging activity at channels 280 (8 strikes) and 327 (17 strikes) respectively.

For each record, calculate mel-frequency features at the moments where impulsive event occurs. These mel-frequency features, model frequency response of the impulse followed by the response of the medium (commonly soil). After this step we would obtain N×M mel-frequency features where N is the impulsive event number record contains and M is the mel-frequency feature number. If the record in FIG. 3 were used for this analysis, we would obtain 8×48 mel-frequency features for the representation of the frequency response of the channel 280.

For each channel where records are taken, get the average of mel-frequency features for different impulsive events. For each channel, this step generates averaged mel-frequency features with size 1×M from N×M mel-frequency features generated at the previous step (If we were to apply this step to the record in FIG. 3, we would obtain averaged mel-frequency features with size 1×48, from the mel-frequency features with size 8×48, to represent frequency response of the channel 280). After doing this operation for a total of L-channel, we would obtain mel-frequency features with size L×M which represents frequency response of the impulsive activity for different channels.

To be able to cover all channels along fiber optic cable, interpolate previously calculated mel-frequency features (with size L×M) with K (channel interval number used to get a recording along fiber, during analysis) along channel axis. This step will produce C×M mel-frequency features (estimate of the frequency response of each channel), where C is the channel number fiber optic cable installed.

Then calculate mel-frequency transformation coefficients values (with size 1×M) for each channel such that when divided by previously calculated mel-frequency features corresponding to same channel, produces mel-frequency features for the C/2^{th} channel (center channel). This operation effectively finds mel-frequency transformation coefficients for each channel to transform frequency response of the channel to the frequency response of the C/2^{th} channel. After this step, we will obtain 1×M mel-frequency transformation coefficients for each channel. (Total of C×M mel-frequency transformation coefficients for all channels).

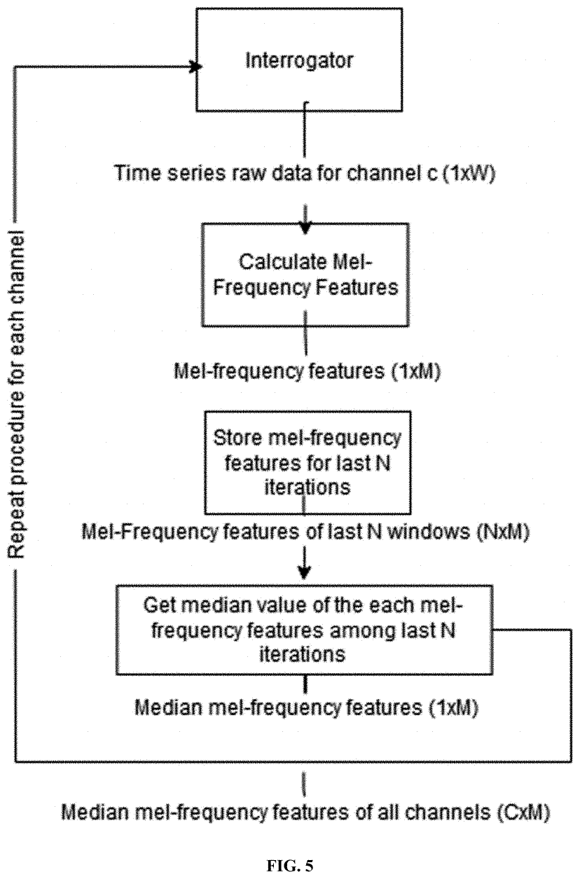

To estimate frequency response of different channels, online frequency response estimation algorithm applies following operations consecutively. The block diagram of the online frequency response estimation algorithm can be seen in FIG. 5.

For each channel calculate the mel-frequency features at every window length W. This step will produce 1×M mel-frequency features for each channel. We would obtain total of C×M mel-frequency features for all channels (C is channel number fiber optic cable installed) at every window.

Store mel-frequency features calculated at the previous step for last N windows. In memory we will have N×M mel-frequency features for each channel, and total of C×N×M mel-frequency features for all channels.

Find median mel-frequency feature representation of each channel, using mel-frequency features data generated, at last N windows. This step will produce 1×M median mel-frequency features (estimate of the frequency response of the channel) from the N×M mel-frequency features which are generated at last N window for each channel.

After having done above operations for all channels, we would obtain median mel-frequency features (with size C×M, where C is the channel number). We will use these parameters as mel-frequency transformation coefficients to compensate for frequency response differences among channels.

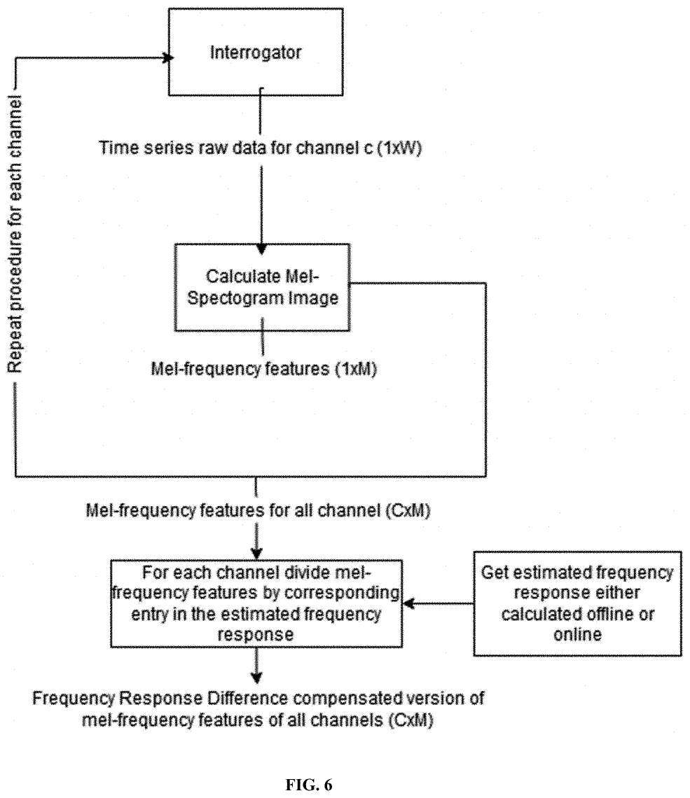

After having calculated mel-frequency transformation coefficients (by estimating mel-frequency response of each channel) either with offline or online method for all channels, at runtime do the following operations to compensate frequency response differences among channels. The block diagram of the compensation algorithm can be seen in FIG. 6.

Calculate mel-frequency features as usual for each channel. Then for each channel get the corresponding mel-frequency transformation coefficients (with size 1×M).

To compensate for differences among frequency response of each channel, divide each mel-frequency feature with the corresponding mel-frequency transformation coefficient to obtain standardized mel-frequency response representation of the channel.

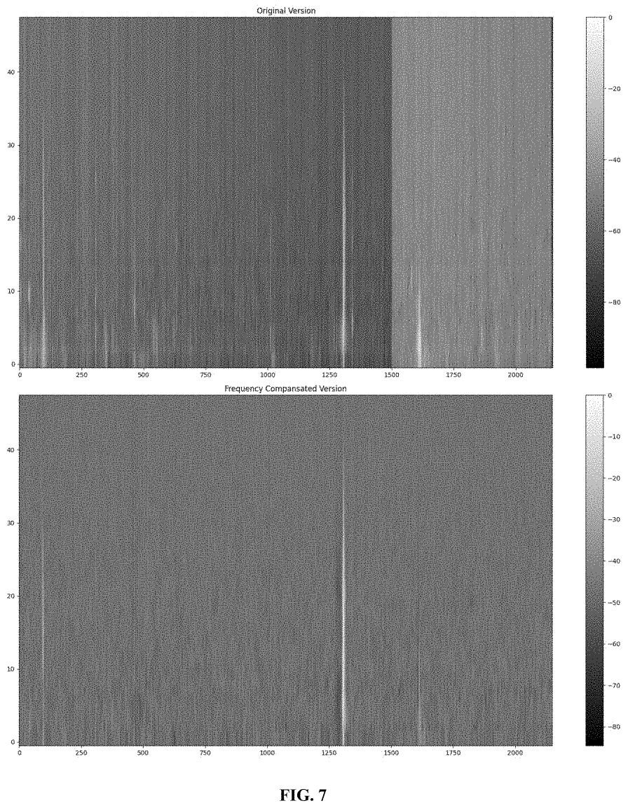

In FIG. 7, we can see the result of the online compensation algorithm described, during a train pass. Upper image in FIG. 7, represents uncompensated mel-frequency features, below image represents compensated mel-frequency features. As can be seen from FIG. 7, background noise and foreground activity are clearly separated after compensation scheme.

We can apply either of these two compensation algorithms to generate standardized mel-frequency features, as an input to the neural networks. By this scheme we decrease the variance of mel-frequency feature space, and normalize among different channels. This enables us to use less training data, smaller architectures for classification and anomalous event detection tasks.

1. A frequency response estimation method to compensate for channel differences in distributed acoustic sensing systems, the method comprising:
calculating mel-frequency transformation coefficients by estimating mel-frequency response of each channel with an offline method or an online method;
calculating mel-frequency features for each channel and getting the corresponding mel-frequency transformation coefficients; and
dividing each mel-frequency feature with the corresponding mel-frequency transformation coefficient to obtain a standardized mel-frequency response representation of the channel.

2. The frequency response estimation method to compensate for channel differences in distributed acoustic sensing systems according to claim 1, wherein the offline method for calculating mel-frequency transformation coefficients comprises:
getting recordings of impulsive events for each channel;
calculating mel-frequency features at the moments where impulsive event occurs for each record;
calculating the average of mel-frequency features for different impulsive events for each channel where records are taken;
interpolating the calculated mel-frequency features with channel interval number used to get a recording along fiber along channel axis to be able to cover all channels along fiber optic cable; and
calculating mel-frequency transformation coefficients values for each channel such that when divided by calculated mel-frequency features corresponding to same channel, produces mel-frequency features for the center channel.

3. The frequency response estimation method to compensate for channel differences in distributed acoustic sensing systems according to claim 1, wherein the online method for calculating mel-frequency transformation coefficients comprises:
calculating mel-frequency features at every window for each channel;
storing the mel-frequency features calculated for last arbitrary chosen number of windows; and
finding median mel-frequency feature representation of each channel, using mel-frequency features data generated, at last chosen number of windows.
